(19) United States
(12) Patent Application Publication
(10) Pub. No.: US 2017/0254975 A1
(43) Pub. Date: Sep. 7, 2017

(54) OPTICAL FIBER SPLICE CASSETTE

(71) Applicant: SENKO Advanced Components (HK) Ltd., Hong Kong (HK)

(72) Inventors: Chi Wang Tai, Shenzhen (CN); An Xiang Liao, Shenzhen (CN)

(21) Appl. No.: 15/361,072

(22) Filed: Nov. 24, 2016

(30) Foreign Application Priority Data
Mar. 3, 2016 (CN) 201610120384.X

(51) Int. Cl. G02B 6/44; G02B 6/255

(52) U.S. Cl. CPC G02B 6/4454; G02B 6/2555

(57) ABSTRACT

A cassette for housing and protecting splices of optical fibers, comprising a substrate and a lid, is provided. The substrate has a substrate body comprising a splice area for allowing the splices to be located thereon. A platform protruding from the substrate body has V-grooves on a top-end surface for guiding the optical fibers. The lid comprises a lid body comprising a platform-facing area for pressing towards the top-end surface when the substrate and the lid are integrated to form an assembled cassette. Multiple legs protruding from the lid body other than the platform-facing area are arranged such that a channel for allowing the optical fibers to pass through is formed between two of the legs. As a result, the channel overlies and covers the splice area to provide physical protection to the splices. The cassette is simple in structure while providing sufficient protection to the splices.

### CLAIM FOR PRIORITY

This application claims priority under the Paris Convention to the China Patent for Invention Application No. 201610120384.X, filed Mar. 3, 2016, the disclosure of which is incorporated herein by reference in its entirety.

### FIELD OF THE INVENTION

The present invention generally relates to a cassette for housing a plurality of splices of optical cables. In particular, the present invention relates to such cassette having a substrate and a lid for protecting the splices.

### BACKGROUND

In building an optical communication network, it is often necessary to connect one optical fiber or optical-fiber segment to another such that a single optical fiber for supporting a longer communication distance is obtained. In joining two optical fibers, fusion splicing is usually used, forming a splice at an interconnection point of the two optical fibers. The splice is often considered a relatively vulnerable part of the resultant optical fiber after joining. It is advantageous to use a sufficiently rigid device to enclose the splice in order to offer protection thereto. Such protection devices include, for example, a multiple optical fiber splice element suggested in U.S. Pat. No. 5,155,787, splice cassettes disclosed in United States Patent Application Publication No. 2014/0348479A1 and United States Patent Application Publication No. 2014/0348480A1, and an optical joint closure detailed in International Patent Application Publication No. WO2014181364A1. However, these protection devices are rather complex in structure, inevitably leading to a high cost in manufacturing these devices. There is a need in the art to have a splice protection device that is simple in structure while providing sufficient protection to a splice housed therein.

### SUMMARY OF THE INVENTION

In one aspect of the present invention, an optical-fiber splice cassette for housing and protecting plural splices of optical fibers is provided.

The cassette comprises a substrate and a lid. The substrate is used for supporting the optical fibers and the splices thereof, and the lid is for partially covering the substrate.

The substrate comprises a substrate body. The substrate body includes a splice area thereon. The splice area is used for allowing the splices to be formed and located thereon. The substrate further comprises a platform protruding from the substrate body and having a top-end surface. The platform includes plural V-grooves on the top-end surface for guiding the optical fibers. An entirety of the V-grooves forms a V-groove area on the top-end surface.

The lid comprises a lid body. The lid body comprises a platform-facing area on the lid. The platform-facing area is configured to cover at least the V-groove area under a working condition. The working condition is that the lid is positioned on the substrate to partially cover the substrate with the platform-facing area pressing towards the top-end surface and the optical fibers running through the V-grooves. The lid further comprises plural legs protruding from a part of the lid body other than the platform-facing area. The legs are arranged such that a channel for allowing the optical fibers to pass through is formed between pre-determined two of the legs. Under the working condition, the channel overlies and covers the splice area to provide physical protection to the splices.

Preferably, each of the V-grooves has a depth selected for the optical fibers having a same, pre-defined diameter. The depth is measured from the top-end surface. In addition, the depth is selected such that the optical fibers are secured inside the V-grooves under the working condition.

Other aspects of the present invention are disclosed as illustrated by the embodiments hereinafter.

### BRIEF DESCRIPTION OF THE DRAWINGS

Embodiments of the present invention are described in more detail hereinafter with reference to the drawings, in which:

FIG. 1 depicts an optical-fiber splice cassette comprising a substrate and a lid in accordance with an exemplary embodiment of the present invention, showing that the lid is put onto the substrate to form the cassette;

FIG. 2A depicts the substrate in a side view; FIG. 2B depicts the substrate in a front view, FIG. 2C depicts the substrate in a top view; and FIG. 2D depicts the substrate in a perspective view;

FIG. 3A depicts the lid in a side view; FIG. 3B depicts the lid in a front view; FIG. 3C depicts the lid in a top view; and FIG. 3D depicts the lid in a perspective view; and

FIG. 4A depicts an example of the cassette after assembling in a top view, where the lid and the substrate are integrated together with an adhesive and plural optical fibers run through an enclosure created by the lid and the substrate, splices of the optical fibers being housed inside the enclosure; FIG. 4B depicts the example of the cassette after assembling in a side view; FIG. 4C depicts the example of the cassette after assembling in a front view; and FIG. 4D depicts the example of the cassette after assembling in a exploded partial front view.

### DETAILED DESCRIPTION

An aspect of the present invention is to provide an optical-fiber splice cassette for housing and protecting plural splices of optical fibers. The cassette is simple in structure while providing sufficient protection to the splices.

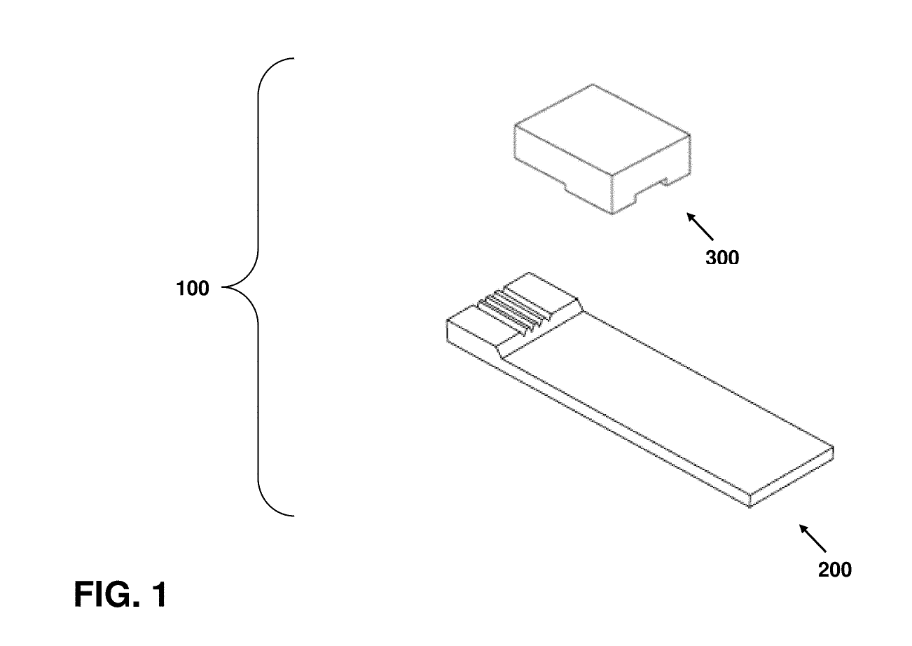

The cassette is exemplarily illustrated with the aid of FIG. 1. A cassette 100 as depicted in FIG. 1 comprises a substrate 200 for supporting the optical fibers and the splices, and a lid 300 for partially covering the substrate 200. The lid 300 is configured to overlie and fit onto the substrate 200.

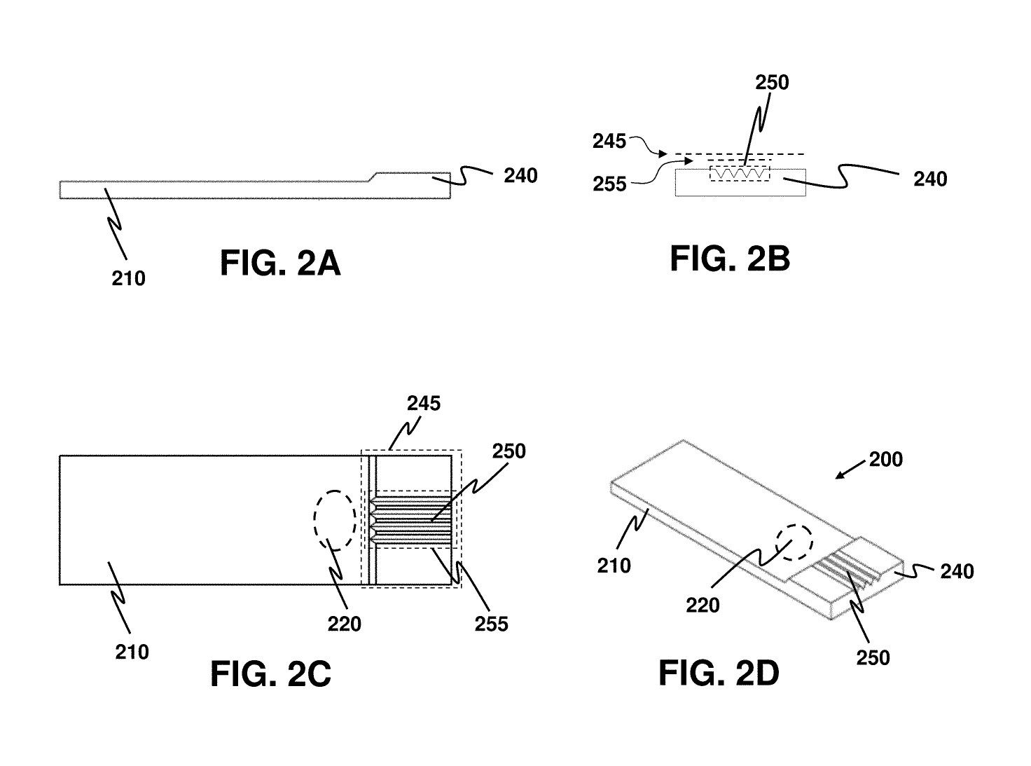

FIGS. 2A, 2B, 2C, and 2D depict a side view, a front view, a top view, and a perspective view of the substrate 200 respectively.

The substrate 200 comprises a substrate body 210 forming a bulk of the substrate 200. The substrate body 210 includes a splice area 220 on the substrate body 210. The splice area 220 is used as an area allowing the splices to be formed and located thereon. To make clear to an engineer or a technician to position original optical fibers on or over the splice area 220 before fusion splicing, preferably the splice area 220 is explicitly indicated on the substrate body 210 by, for example, painting a visual mark on the substrate body 210.

The substrate 200 further comprises a platform 240 protruding from the substrate body 210 and having a top-end surface 245. Note that the top-end surface 245 is a surface of the platform 240 and is separate from the substrate body 210. The top-end surface 245 is usually manufactured to be substantially planar (as shown in FIGS. 2A-2D) in practical realization of the substrate 200, but the present invention is not limited only to this choice. The platform 240 further includes plural V-grooves 250 on the top-end surface 245, where each of the V-grooves 250 is formed as a V-shaped passage receded from the top-end surface 245. The V-grooves 250 are used for accommodating the optical fibers one-by-one so as to guide the optical fibers to point along a desired direction when the fibers run through the V-grooves 250. Usually in practical implementations, the V-grooves 250 have approximately the same depth in order to accommodate the optical fibers that have a same, pre-determined diameter. The V-grooves 250 may also be arranged to be substantially-evenly spaced, substantially parallel in orientation, or both, in some practical implementations. Although the number of the V-grooves 250 shown in FIGS. 2B-2D is four, the present invention is not limited only to this number; the number of the V-grooves 250 may be any positive number. An entirety of the V-grooves 250 forms a V-groove area 255 on the top-end surface 245.

In one embodiment, the substrate 200 is made of pyrex.

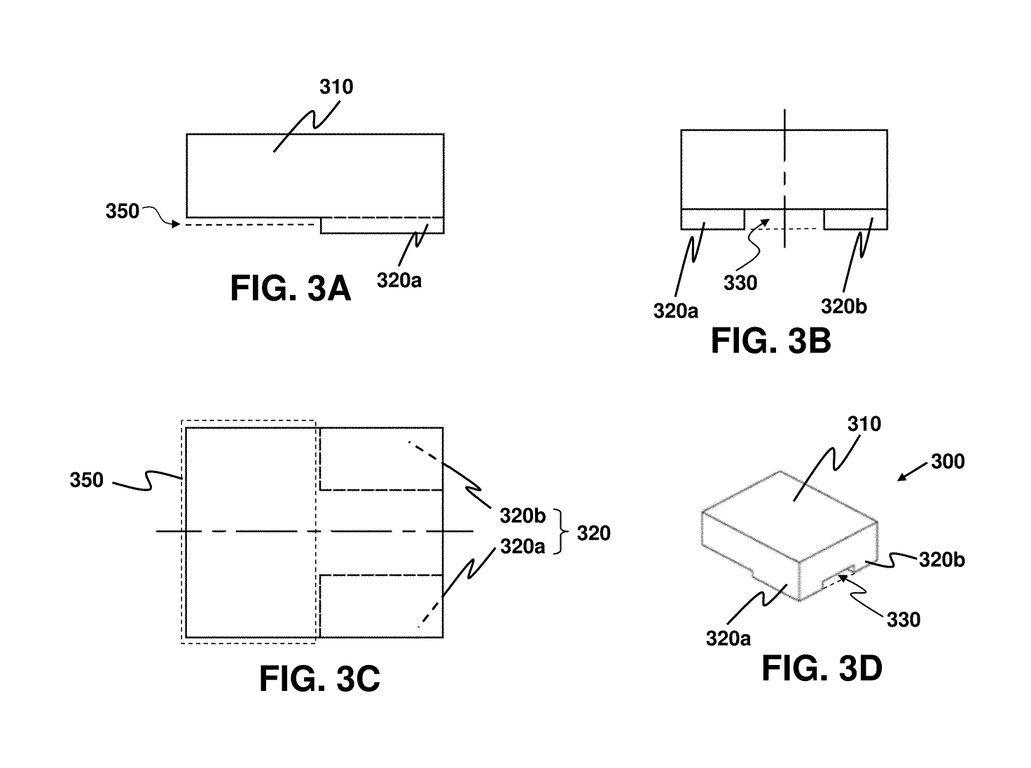

FIGS. 3A, 3B, 3C, and 3D depict a side view, a front view, a top view, and a perspective view of the lid 300 respectively.

The lid 300 comprises a lid body 310 that forms a bulk of the lid 300. The lid body 310 includes a platform-facing area 350. The platform-facing area 350 is intended to face the platform 240 of the substrate 200 and is configured to cover at least the V-groove area 255, when the engineer or the technician puts the lid 300 to partially cover the substrate 200 in forming the cassette 100. In making the lid 300, the platform-facing area 350 is usually manufactured to be substantially planar (as shown in FIGS. 3A, 3B, 3C, and 3D), especially if the top-end surface 245 of the substrate 200 is selected to be also substantially planar.

The lid 300 further comprises plural legs 320 protruding from a part of the lid body 310 other than the platform-facing area 350. Although FIGS. 3B-3D show that the number of the legs 320 (consisting of legs 320a, 320b) is two as an example for illustration, the present invention is not limited only to two legs. It is possible to have any number of the legs. For example, partitioning each of the legs 320a, 320b gives four resultant legs in total. Regardless of the number of the legs 320 used in the lid 300, the legs 320 are arranged such that a channel 330 for allowing the optical fibers to pass through is formed between pre-determined two of the legs 320 (e.g., the legs 320a, 320b shown in FIG. 3).

In one embodiment, the lid 300 is made of pyrex.

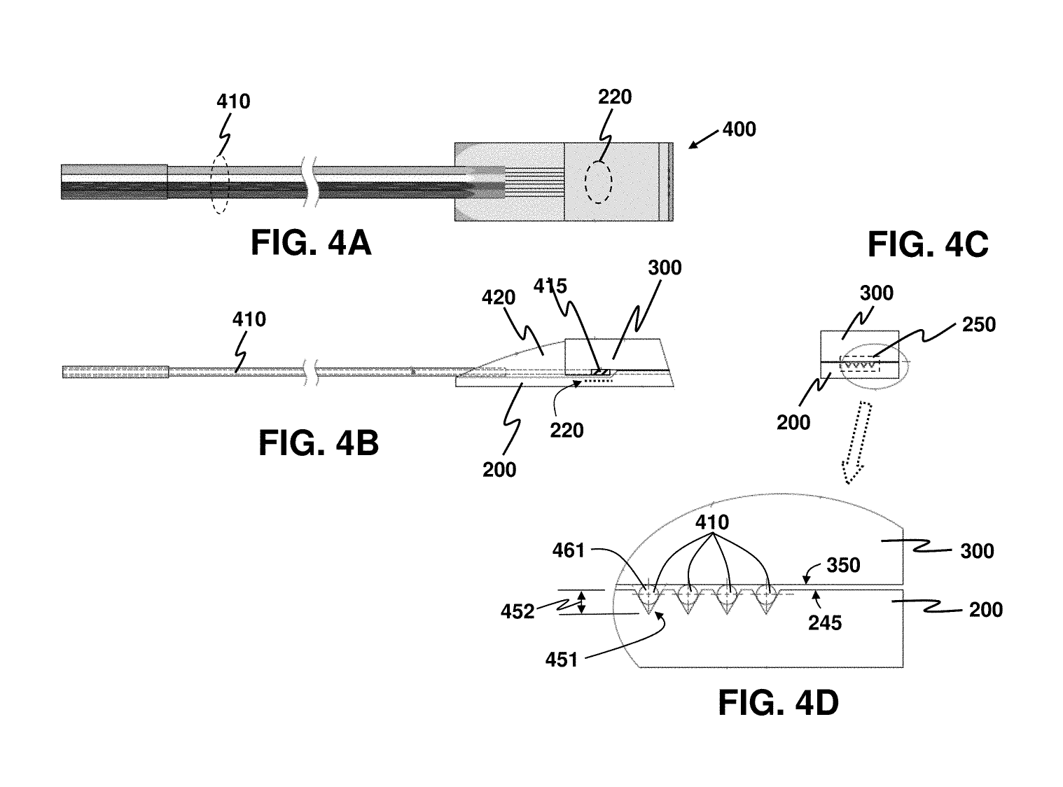

FIGS. 4A, 4B, 4C, and 4D show an example of an assembled cassette 400 integrally formed by the substrate 200 and the lid 300 as disclosed above, with a plurality of (bundled) optical fibers 410 attached to the assembled cassette 400 after fusion splicing is done, where a top view, a side view and a front view of the assembled cassette 400 are depicted in FIGS. 4A, 4B, and 4C, respectively. It is apparent that a working condition of the assembled cassette 400 (or equivalently, the cassette 100) is that the lid 300 is positioned on the substrate 200 to partially cover the substrate 200 with the platform-facing area 350 pressing towards the top-end surface 245 and the optical fibers 410 running through the V-grooves 250. Splices 415 generated by fusion splicing of the optical fibers 410 are positioned over the splice area 220. The splices 415 are located between the lid 300 and the substrate 200 and are at least partially enclosed inside the channel 330 created by the two legs 320a, 320b. Thus, under the working condition, the channel 330 overlies and covers the splice area 220 to provide physical protection to the splices 415.

FIG. 4D shows an enlarged view of a part shown in the front view as depicted in FIG. 4C, and serves to illustrate that the lid 300 is preferably used to secure the optical fibers 410 inside the V-grooves 250. Consider a practical case that the optical fibers 410 have a same, pre-defined diameter, and consider a fiber 461 selected from the optical fibers 410 as an example for illustration. The considered fiber 461 resides in a receiving V-groove 451, namely, the leftmost one of the optical fibers 410 shown in FIG. 4D. The receiving V-groove 451 has a depth 452, measured from the top-end surface 245. In particular, the depth 452 is intentionally selected such that when the considered fiber 461 resides in the receiving V-groove 451, part of the considered fiber 461 is exposed above the top-end surface 245. Under the working condition, the platform-facing area 350 presses towards the top-end surface 245. It follows that the considered fiber 461 is held immobilized inside the receiving V-groove 451, and is thus secured.

To bind the lid 300 and the substrate 200 to form the assembled cassette 400, an adhesive 420 such as a resin may be used.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

1. An optical-fiber splice cassette for housing and protecting plural splices of optical fibers, the cassette comprising a substrate for supporting the optical fibers and the splices, and a lid for partially covering the substrate, the substrate comprising:
a substrate body comprising a splice area thereon, the splice area allowing the splices to be formed and located thereon; and
a platform protruding from the substrate body and having a top-end surface, the platform including plural V-grooves on the top-end surface for guiding the optical fibers, an entirety of the V-grooves forming a V-groove area on the top-end surface;
the lid comprising:
a lid body comprising a platform-facing area on the lid, the platform-facing area being configured to cover at least the V-groove area under a working condition that the lid is positioned on the substrate to partially cover the substrate with the platform-facing area pressing towards the top-end surface and the optical fibers running through the V-grooves; and
plural legs protruding from a part of the lid body other than the platform-facing area, the legs being arranged such that a channel for allowing the optical fibers to pass through is formed between pre-determined two of the legs, wherein under the working condition, the channel overlies and covers the splice area to provide physical protection to the splices.

2. The optical-fiber splice cassette of claim 1, wherein each of the V-grooves has a depth selected for the optical fibers having a same, pre-defined diameter such that the optical fibers are secured inside the V-grooves under the working condition, the depth being measured from the top-end surface.

3. The optical-fiber splice cassette of claim 1, wherein the platform-facing area is substantially planar.

4. The optical-fiber splice cassette of claim 1, wherein the number of V-grooves is four.

5. The optical-fiber splice cassette of claim 1, wherein the number of the legs is two.

6. The optical-fiber splice cassette of claim 1, wherein the V-grooves are substantially-evenly spaced, substantially parallel in orientation, or both.

7. The optical-fiber splice cassette of claim 1, wherein the substrate is made of pyrex.

8. The optical-fiber splice cassette of claim 1, wherein the lid is made of pyrex.

9. The optical-fiber splice cassette of claim 1, wherein the lid and the substrate are bound together with an adhesive.

10. The optical-fiber splice cassette of claim 9, wherein the adhesive is a resin.

11. The optical-fiber splice cassette of claim 2, wherein the platform-facing area is substantially planar.

12. The optical-fiber splice cassette of claim 2, wherein the number of V-grooves is four.

13. The optical-fiber splice cassette of claim 2, wherein the number of the legs is two.

14. The optical-fiber splice cassette of claim 2, wherein the V-grooves are substantially-evenly spaced, substantially parallel in orientation, or both.

15. The optical-fiber splice cassette of claim 2, wherein the substrate is made of pyrex.

16. The optical-fiber splice cassette of claim 2, wherein the lid is made of pyrex.

17. The optical-fiber splice cassette of claim 2, wherein the lid and the substrate are bound together with an adhesive.

18. The optical-fiber splice cassette of claim 17, wherein the adhesive is a resin.
